(19) United States
(12) Patent Application Publication
(10) Pub. No.: US 2008/0075461 A1
(43) Pub. Date: Mar. 27, 2008

(54) Wavelength Division Multiplexing Passive Optical Network System Adopted Dual Central Office

(75) Inventors: Jun-Kook Choi, Seoul (KR); So-Young Lee, Gyeongsangbuk-do (KR); Soung-Min Kang, Gyeongsangbuk-do (KR)

Correspondence Address: CANTOR COLBURN, LLP, 20 Church Street, 22nd Floor, Hartford, CT, 06103, US

(73) Assignees: JUN-KOOK CHOI, Gangnam-gu, Seoul (KR); CYBERTRON CO., LTD., Guro-gu, Seoul (KR)

(21) Appl. No.: 11/587,783

(22) PCT Filed: Apr. 22, 2005
(86) PCT No.: PCT/KR05/01162

§ 371 Date: Nov. 30, 2007

(30) Foreign Application Priority Data
Apr. 26, 2004 (KR) 10-2004-0028756

(51) Int. Cl. H04L 12/28; H04J 14/00

(52) U.S. Cl. 398/48

(57) ABSTRACT

Disclosed herein is a Wavelength Division Multiplexing (WDM) Passive Optical Network (PON) system having a dual central office. The WDM PON system is configured to guarantee system stability by employing a plurality of central offices on a ring type optical communication line and allowing another central office to assume control when a problem occurs in one central office, and further to appropriately compensate for various types of loss caused by various environmental factors, such as insertion loss caused by interfacing various devices with a ring type optical communication line and loss caused by the degradation of an optical cable.

### TECHNICAL FIELD

The present invention relates, in general, to a wavelength division multiplexing passive optical network system and, more particularly, to a wavelength division multiplexing passive optical network system, in which system stability can be guaranteed by employing a plurality of central offices on a ring type optical communication line and, therefore, allowing another central office to assume control when a problem occurs in one central office.

### BACKGROUND ART

Wavelength Division Multiplexing (WDM) is a method in which a Central Office (CO) assigns different wavelengths to individual subscribers and data are simultaneously transmitted. Each subscriber can always transmit or receive data using an assigned wavelength. This method is advantageous in that a large volume of data can be transmitted to each subscriber, the security of communication is excellent and it is easy to improve performance.

Meanwhile, a Passive Optical Network (PON), that is, one of the methods of constructing Fiber-to-the-home (FTTH), is a method in which one Optical Line Termination (OLT) can connect a plurality of Optical Network Units (ONUs) using a passive optical distribution device on a single optical cable. In the PON, data are transmitted from the CO up to a Remote Node (RN) over a single optical fiber, divided by the passive optical distribution device of the RN, and then transmitted to individual subscribers over separate optical fibers. That is, the PON has a configuration in which a CO is connected to an RN installed at a location adjacent to subscribers via a single optical fiber and the RN is connected to individual subscribers via separate optical fibers, so that the cost of cables can be reduced compared to the case where individual optical cables are installed to run all the way from the CO to the subscribers.

One WDM PON system can be implemented by combining the above-described WDM technology and PON technology together. Such a WDM PON system generally employs a redundant structure having redundant components so as to substitute for a cut optical fiber, a defective Laser Diode (LD; corresponding to an optical transmission unit) or a defective Photodiode (PD; corresponding to an optical reception unit).

The applicant of the present invention proposed a WDM PON system that is capable of extending the life spans of optical sources and lowering the transmission error rate of data packets by fundamentally blocking light that can be introduced into the optical sources, in Korean Pat. Appl. No. 2003-98904 (filed on Dec. 29, 2003).

FIG. 1 is a schematic diagram of the WDM PON system that was proposed in Korean Pat. Appl. No. 2003-98904 filed by the applicant of the present invention.

As shown in the drawing, the WDM PON system includes a ring type optical communication line 100, a CO 200 and a plurality of RNs 300. The CO 200 is connected to the plurality of RNs 300 through the ring type optical communication line 100.

The CO 200 includes a plurality of optical transmission units 210 that generates optical signals having different wavelengths, and a plurality of optical reception units 220 each of which forms a pair with a corresponding optical transmission unit 210, receives an optical signal having the same wavelength as the corresponding optical transmission unit 210, and converts the optical signal into an electrical signal. In this case, implementation can be conducted so that the optical transmission units 210 generate an optical signal having a single wideband wavelength rather than optical signals having different wavelengths, and optical signals having different wavelengths are produced using a grating device (not shown).

The CO 200 further includes a multiplexer/demultiplexer 230 that multiplexes the optical signals of different wavelengths, which are received through optical circulators 240 that will be described later, and then outputs a multiplexed optical signal to the optical communication line 100, and demultiplexes the multiplexed optical signal that is received through the optical communication line 100 and then outputs demultiplexed optical signals to the optical circulators 240.

The CO 200 further includes a plurality of optical circulators 240, each of which outputs an optical signal, which is output from a designated one of the optical transmission units 210, to the multiplexer/demultiplexer 230, and outputs one of the optical signals, which are demultiplexed by and received from the multiplexer/demultiplexer 230, to a designated one of the optical reception units 220.

The optical circulators 240 are optical devices that are designed such that light incident through an input port is not allowed to return to the same port at all. This implies that light generated from an optical source is not introduced into the same optical source regardless of the path by which it travels.

Each of the RNs 300 includes an optical add/drop multiplexer 310 that drops only signals having wavelengths in a predetermined band from the optical signals transmitted through the optical communication line 100 and outputs the dropped signals to subscriber devices (not shown), and also outputs optical signals received from the optical transmission units of the subscriber devices to the optical communication line 100, and a plurality of optical circulators 321a and 321b that outputs optical signals that are dropped through the optical add/drop multiplexer 310 to the optical reception units of the subscriber devices, and outputs optical signals that are received from the optical transmission units of the subscriber devices to the optical add/drop multiplexer 310.

Meanwhile, Korean Pat. Appl. No. 2003-98904 filed by the applicant of the present invention proposed a WDM PON system that employed a general Media Converter (MC) as still another embodiment.

In the example, a CO 200 includes a plurality of general MCs that includes a plurality of optical transmission units 210 that generate optical signals having different wavelengths, a plurality of optical reception units 220 each of which forms a pair with a corresponding one of the optical transmission units 210, receives an optical signal having the same wavelength as the corresponding optical transmission unit 210 and converts the received optical signal into an electrical signal, a multiplexer/demultiplexer 230 that multiplexes optical signals having different wavelengths, which are received from the general MCs and then outputs the multiplexed optical signal to an optical communication line 100, and demultiplexes a multiplexed optical signal received through the optical communication line 100 and then outputs the demultiplexed optical signals to the general MCs, and a plurality of optical circulators 240 that output the optical signals output from the optical transmission units 210 of the general MCs to the multiplexer/demultiplexer 230, and outputs the optical signals, which are demultiplexed in the multiplexer/demultiplexer 230, to the optical reception units 220 of the general MCs.

The WDM PON system, which was proposed in Korean Pat. Appl. No. 2003-98904 filed by the applicant of the present invention, employed an optical coupler 400 between the multiplexer/demultiplexer 230 of the CO 200 and the optical communication line 100, and the optical coupler 400 functions to divide a multiplexed signal output from the multiplexer/demultiplexer 230 and then transmit the divided signals to different optical communication lines 100, and transmit an optical signal output from one of the optical communication lines 100 to the multiplexer/demultiplexer 230.

### DESCRIPTION OF DRAWINGS

FIG. 1 is a schematic diagram of a WDM PON system;

FIG. 2 is a diagram showing the construction of a WDM PON system having a dual CO according to a first embodiment of the present invention;

FIG. 3 is a diagram showing the construction of a WDM PON system having a dual CO according to a second embodiment of the present invention;

FIG. 4 is a diagram showing the construction of a WDM PON system having a dual CO according to a third embodiment of the present invention;

FIG. 5 is a diagram showing the construction of a WDM PON system having a dual CO according to a fourth embodiment of the present invention;

FIG. 6 is a diagram showing a first embodiment of a signal compensation unit applied to the WDM PON systems having a dual CO according to the present invention;

FIG. 7 is a diagram showing a second embodiment of a signal compensation unit applied to the WDM PON systems having a dual CO according to the present invention; and

FIG. 8 is a diagram showing a third embodiment of a signal compensation unit applied to the WDM PON systems having a dual CO according to the present invention.

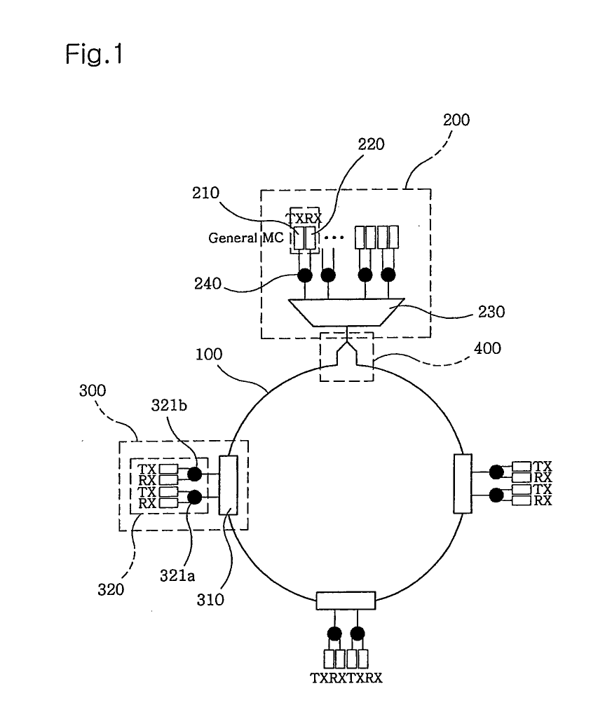

### DISCLOSURE

### Technical Problem

The above-described WDM PON system, which was proposed in previously filed Korean Pat. Appl. No. 2003-98904, employs a single CO, and does not employ a redundant structure so as to substitute for a CO and assume the control of the CO when a problem occurs in the CO, so that a problem occurs in that the system is downed.

Therefore, the inventor of the present invention carried out research into a WDM PON system having a dual CO that guarantees system stability by employing a plurality of COs on a ring type optical communication line and, therefore, allowing another CO to assume control when a problem occurs in one CO.

### Technical Solution

Accordingly, the present invention has been made keeping in mind the above problems occurring in the prior art, and an object of the present invention is to provide a WDM PON system having a dual CO, in which system stability can be guaranteed by employing a plurality of COs on a ring type optical communication line and, therefore, allowing another CO to assume control when a problem occurs in one CO.

Another object of the present invention is to provide a WDM PON system having a dual CO, which can appropriately compensate for various types of loss caused by various environmental factors, such as insertion loss caused by interfacing various devices with a ring type optical communication line and loss caused by the degradation of an optical cable.

### Advantageous Effects

A WDM PON system having a dual CO according to the present invention has advantages in that system stability can be guaranteed by employing a plurality of COs on a ring type optical communication line and, therefore, allowing another CO to assume control when a problem occurs in one CO, and in that various types of loss caused by various environmental factors, such as insertion loss caused by interfacing various devices with a ring type optical communication line and loss caused by the degradation of an optical cable, can be appropriately compensated for.

### Best Mode

In order to accomplish the above objects, the present invention provides Wavelength Division Multiplexing (WDM) Passive Optical Network (PON) system having a dual Central Office (CO), including a ring type optical communication line; a CO including a plurality of optical transmission units for generating optical signals having different wavelengths, a plurality of optical reception units for forming pairs with respective optical transmission units, receiving optical signals having the same wavelengths as the corresponding optical transmission units, converting the received optical signals into electrical signals and then outputting the converted electrical signals, a multiplexer/demultiplexer for multiplexing input optical signals having different wavelengths and then outputting a multiplexed optical signal to the optical communication line, and demultiplexing a multiplexed optical signal input through the optical communication line and then outputting demultiplexed optical signals, and a plurality of optical circulators for outputting an optical signal, output from an assigned optical transmission unit, to the multiplexer/demultiplexer, and outputting input optical signals, demultiplexed by the multiplexer/demultiplexer, to the assigned optical transmission unit; and at least one remote node having an optical add/drop multiplexer for dropping only signals having wavelengths in a specific band, from optical signals transmitted through the optical communication line and outputting to a subscriber side, and outputting optical signals transmitted from the subscriber side to the optical communication line, and an optical circulator for outputting the optical signals, dropped by the optical add/drop multiplexer, to the optical reception units of subscribers' devices, and outputting the optical signals, received from the optical transmission units of the subscribers' devices, to the optical add/drop multiplexer; the WDM PON system comprising: a plurality of COs; a first connection unit having a connection of an odd number of 1×2 couplers, the one side branched ends of one of which are alternately connected to one side branched ends of another 1×2 coupler, and which divide and transmit multiplexing signals, output from multiplexer/demultiplexers of the plurality of COs, and input signals, transmitted through branched paths, to the multiplexer/demultiplexers; a second connection unit having n signal compensation units, whose number is identical to the number of the 1×2 couplers of the first connection unit, that are connected to the branched paths of the first connection unit and compensate the signals transmitted and received through the multiplexer/demultiplexers; and a third connection unit for connecting the signal compensation units with at least one ring type optical communication line, thereby allowing signals to be transmitted and received between the multiplexer/demultiplexers and the ring type optical communication line.

### Mode for Invention

The present invention is described in detail below using preferred embodiments described with reference to the accompanying drawings so as to be easily understood and implemented by those skilled in the art.

The technical gist of a WDM PON system having a dual COs according to the present invention resides in being implemented by applying a plurality of COs to the WDM PON system proposed in Korean Pat. Appl. No. 2003-98904, previously filed by the applicant of the present invention, connecting a plurality of multiplexer/demultiplexers 230 with at least one optical communication line 100 using a first connection unit 410, a second connection unit 420 and a third connection unit 430 and, therefore, allowing another CO to assume control when a problem occurs in any one of the COs.

The first connection unit 410 includes a connection of an odd number of 1×2 couplers, the one side branched ends of one of which are alternately connected to the one side branched ends of another coupler, and which divide and transmit multiplexed signals, which are output from the multiplexer/demultiplexers of the plurality of the COs, and input signals, which are transmitted through branched paths, to the multiplexer/demultiplexers.

The second connection unit 420 includes n signal compensation units whose number is identical to the number of the 1×2 couplers of the first connection unit 410, and which are connected to the branched paths of the first connection unit 410, and compensate signals transmitted and received through the plurality of multiplexer/demultiplexers.

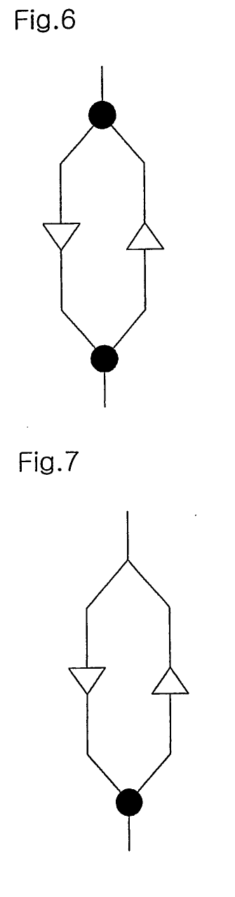

The signal compensation units are used to compensate for various types of loss caused by various environmental factors, such as insertion loss caused by interfacing various devices with an optical communication line and loss caused by the degradation of an optical cable, and detailed embodiments thereof are shown in FIGS. 6 to 8.

The signal compensation unit shown in FIG. 6 includes a first optical circulator, a second optical circulator and a pair of amplifiers.

The first circulator allows signals output from the first connection unit 410 and signals input to the first connection unit 410 to be transmitted and received through different paths.

The second circulator allows signals output from the third connection unit 430 and signals input to the third connection unit 430 to be transmitted and received through different paths.

The amplifiers are installed on two respective paths between the first and second optical circulators in opposite directions, and amplify and compensate signals transmitted and received through the two paths.

Input and output paths are different due to the configuration of the optical circulators, so that signals output from the CO 200 are transmitted to the ring type optical communication line 100 through one of two paths formed by the first and second optical circulators, and signals input from the ring type optical communication line 100 are output to the CO 200 through the other one. Transmitted signals are amplified by the amplifiers installed on the two paths in opposite directions, so that various types of loss caused by various environmental factors, such as insertion loss caused by interfacing various devices with the optical communication line and loss caused by the degradation of an optical cable, are compensated for.

The signal compensation unit shown in FIG. 7 includes a 1×2 coupler, an optical circulator and a pair of amplifiers.

The 1×2 coupler divides and outputs a signal output from the first connection unit 410, and outputs signals, which are transmitted through branched paths, to the first connection unit 410.

The optical circulator allows signals output from the third connection unit 430 and signals input to the third connection unit 430 to be transmitted and received through different paths.

The amplifiers are installed on two respective paths between the 1×2 coupler and the optical circulator in opposite directions, and amplify and compensate signals transmitted and received through the two paths.

This configuration reduces the cost by using one optical circulator, unlike the example shown in FIG. 6, which uses two optical circulators.

Input and output paths are different due to the configuration of the optical circulator, so that signals output from the CO 200 are transmitted to the ring type optical communication line 100 through one of two paths formed by the 1×2 coupler and the optical circulator, and signals input from the ring type optical communication line 100 are output to the CO 200 through the other one. Transmitted signals are amplified by the amplifiers installed on the two paths in opposite directions, so that various types of loss caused by various environmental factors, such as insertion loss caused by interfacing various devices with an optical communication line and loss caused by the degradation of an optical cable, are compensated for.

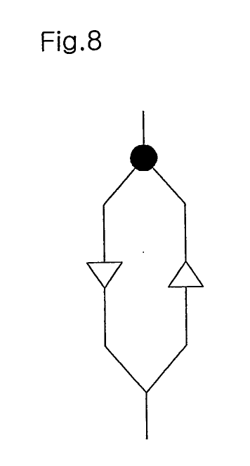

The signal compensation unit shown in FIG. 8 includes an optical circulator, a 1×2 coupler and a pair of amplifiers.

The optical circulator allows signals output from the first connection unit 410 and signals input to the first connection unit 410 to be transmitted and received through different paths.

The 1×2 coupler divides and output a signal output from the third connection unit 430, and outputs signals, which are transmitted through branched paths, to the third connection unit 430.

The amplifiers are installed on two respective paths between the optical circulator and the 1×2 coupler in opposite directions, and amplify and compensate signals transmitted and received through the two paths.

This configuration reduces the cost by using one optical circulator, as in the example shown in FIG. 7, which also uses one optical circulator, but is different from the embodiment shown in FIG. 7 in that it allows the optical circulator to be connected to the first connection unit 410, unlike the embodiment shown in FIG. 7, which is configured such that the optical circulator is connected to the third connection unit 430.

Input and output paths are different due to the configuration of the optical circulator, so that signals output from the CO 200 are transmitted to the ring type optical communication line 100 through one of two paths formed by the optical circulator and the 1×2 coupler, and signals input from the ring type optical communication line 100 are output to the CO 200 through the other one. Transmitted signals are amplified by the amplifiers installed on the two paths in opposite directions, so that various types of loss caused by various environmental factors, such as insertion loss caused by interfacing various devices with an optical communication line and loss caused by the degradation of an optical cable, are compensated for.

The third connection unit 430 connects each of the signal compensation units of the second connection unit with at least one ring type communication line 100, so that signals are transmitted and received between the multiplexer/demultiplexers 230 and the ring type optical communication line 100.

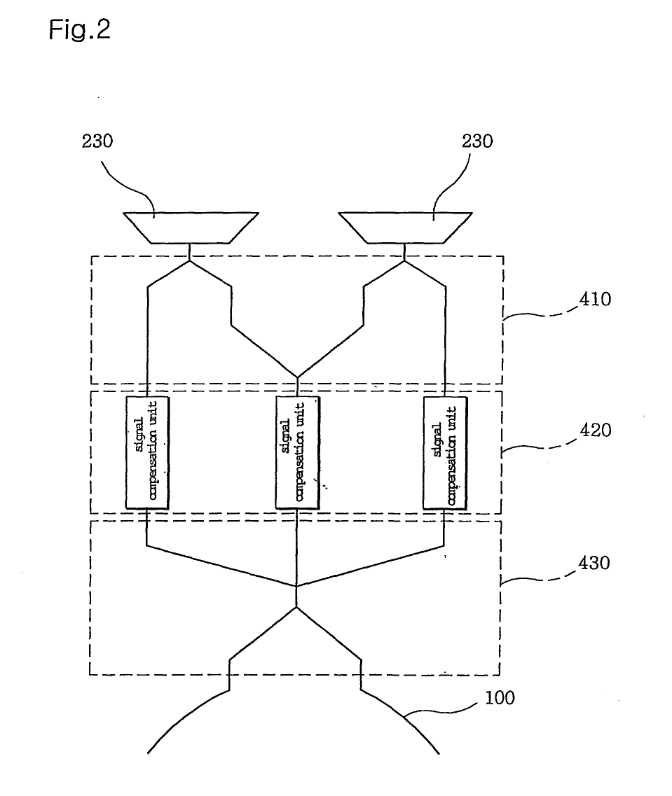

With reference to FIGS. 2 to 5, the detailed construction of the third connection unit 430 is described.

FIG. 2 is a diagram showing the construction of a WDM PON system having a dual CO according to a first embodiment of the present invention.

The WDM PON system having a dual CO according to the first embodiment of the present invention employs an n×2 coupler as the third connection unit 430.

The n×2 coupler is connected between the n signal compensation units of the second connection unit 420 and the single ring type optical communication line 100, outputs signals, which are output through the second connection unit 420, to the optical communication line 100, and output signals, which are input to the optical communication line 100, to the plurality of COs 200 via the second connection unit 420.

Accordingly, when a problem occurs in a currently used CO while signals are exchanged with the local nodes 300 through the ring type optical communication line 100 using any one of the plurality of COs, the signals are exchanged the local nodes 300 through the ring type optical communication line 100 using another CO, so that system stability can be guaranteed.

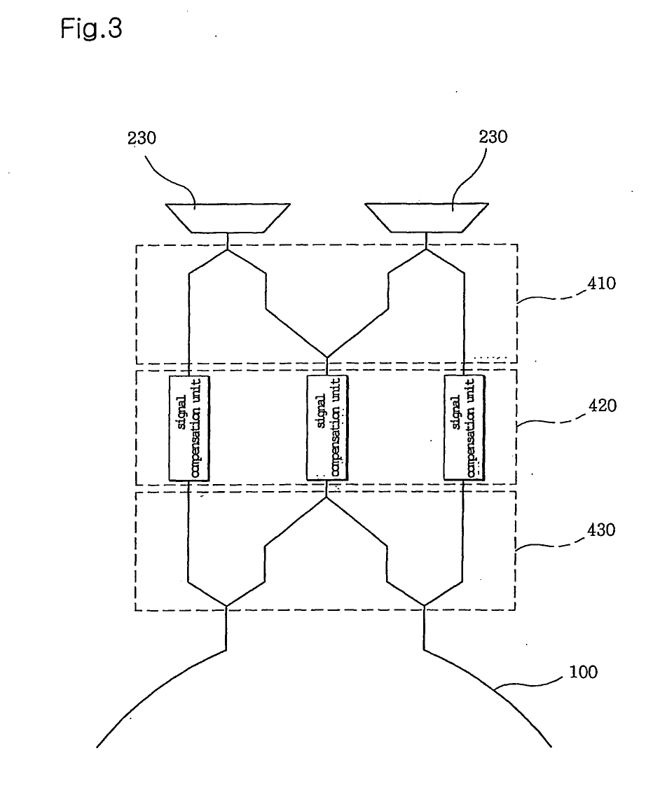

FIG. 3 is a diagram showing the construction of a WDM PON system having a dual CO according to a second embodiment of the present invention.

The WDM PON system having a dual CO according to the second embodiment of the present invention employs n 1×2 couplers as a second connection unit 420.

The n 1×2 couplers are configured such that the one side branched ends of one of the 1×2 couplers are alternately connected to the one side branched ends of another coupler, thus dividing a signal, which is received from a single ring type communication line 100, and then outputting the branched signals to the second connection unit 420, or outputting signals, which are transmitted from the n signal compensation units, to the single ring type communication line 100.

Accordingly, when a problem occurs in a currently used CO while signals are exchanged with the local nodes 300 through the ring type optical communication line 100 using any one of the plurality of COs, the signals are exchanged with the local nodes 300 through the ring type optical communication line 100 using another CO, so that system stability can be guaranteed.

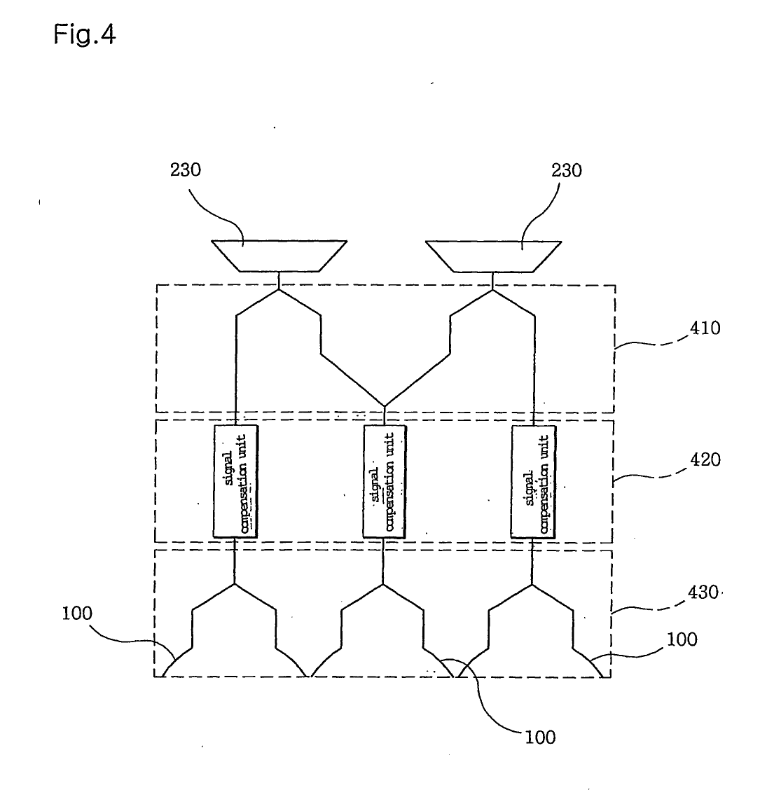

FIG. 4 is a diagram showing the construction of a WDM PON system having a dual CO according to a third embodiment of the present invention.

The WDM PON system having a dual CO according to the third embodiment of the present invention is provided with n ring type optical communication lines 100 so as to accommodate a large number of subscribers, and employs n 1×2 couplers as a third connection unit 430.

The n 1×2 couplers are connected between the n signal compensation units of a second connection unit 420 and the n ring type communication lines 100, respectively, thus transmitting signals, which are output from the second connection unit 420, to the ring type optical communication lines 100, or outputting signals, which are input from ring type optical communication lines 100, to the second connection unit 420.

Accordingly, when a problem occurs in a currently used CO while signals are exchanged with the local nodes 300 through the ring type optical communication lines 100 using any one of the plurality of COs, the signals are exchanged with the local nodes 300 through the ring type optical communication line 100 using another CO, so that system stability can be guaranteed.

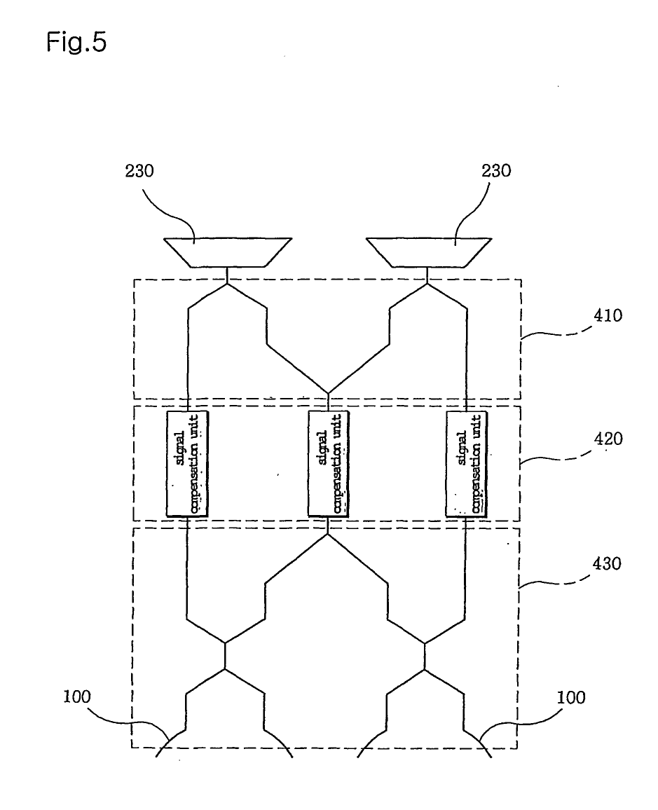

FIG. 5 is a diagram showing the construction of a WDM PON system having a dual CO according to a fourth embodiment of the present invention.

The WDM PON system having a dual CO according to the fourth embodiment of the present invention is provided with (n+1)/2 ring type optical communication lines 100 so as to accommodate a large number of subscribers, and employs a connection of (n−1)/2 1×2 couplers connected to the signal compensation units of a second connection unit 420 and (n+1)/2 2×2 couplers connected to (n+1)/2 ring type optical communication lines 100 as a third connection unit 430.

The (n+1)/2 1×2 couplers and the (n−1)/2 2×2 couplers are installed such that the one side branched ends of one of the couplers are alternately connected to the one side branched end of another coupler, thus allowing signals transmitted and received between the second connection unit 420 and (n+2)/2 ring type optical communication line 100 to be transmitted the paths connected thereby.

Accordingly, when a problem occurs in a currently used CO while signals are exchanged with the local nodes 300 through the ring type optical communication lines 100 using any one of the plurality of COs, the signals are exchanged with the local nodes 300 through the ring type optical communication lines 100 using another CO, so that system stability can be guaranteed.

Therefore, by doing so, the objects of the multi-ring type WDM PON system having a dual CO according to the present invention can be accomplished.

Although the present invention has been described with reference to the accompanying drawings with emphasis on the preferred embodiments, it is apparent to those skilled in the art that various modifications can be made based on the above description without departing from the scope of the present invention defined by the following claims.

1. Wavelength Division Multiplexing (WDM) Passive Optical Network (PON) system having a
dual Central Office (CO), including:
a ring type optical communication line;
a CO including a plurality of optical transmission units for generating optical signals having different wavelengths, a plurality of optical reception units for forming pairs with respective optical transmission units, receiving optical signals having same wavelengths as the corresponding optical transmission units, converting the received optical signals into electrical signals and then outputting the converted electrical signals, a multiplexer/demultiplexer for multiplexing input optical signals having different wavelengths and then outputting a multiplexed optical signal to the optical communication line, and demultiplexing a multiplexed optical signal input through the optical communication line and then outputting demultiplexed optical signals, and a plurality of optical circulators for outputting an optical signal, output from an assigned optical transmission unit, to the multiplexer/demultiplexer, and outputting input optical signals, demultiplexed by the multiplexer/demultiplexer, to the assigned optical transmission unit; and
at least one remote node having an optical add/drop multiplexer for dropping only signals having wavelengths in a specific band, from optical signals transmitted through the optical communication line and outputting to a subscriber side, and outputting optical signals transmitted from the subscriber side to the optical communication line, and an optical circulator for outputting the optical signals, dropped by the optical add/drop multiplexer, to optical reception units of subscribers' devices, and outputting the optical signals, received from optical transmission units of the subscribers' devices, to the optical add/drop multiplexer;
the WDM PON system comprising:
a plurality of COs;
a first connection unit having a connection of an odd number of 1×2 couplers, the one side branched ends of one of which are alternately connected to one side branched ends of another 1×2 coupler, and which divide and transmit
multiplexing signals, output from multiplexer/demultiplexers of the plurality of COs, and input signals, transmitted through branched paths, to the multiplexer/demultiplexers;
a second connection unit having n signal compensation units, whose number is identical to a number of the 1×2 couplers of the first connection unit, which are connected to the branched paths of the first connection unit and compensate the signals transmitted and received through the multiplexer/demultiplexers; and
a third connection unit for connecting the signal compensation units with at least one ring type optical communication line, thereby allowing signals to be transmitted and received between the multiplexer/demultiplexers and the ring type optical communication line.

2. The WDM PON system according to claim 1, wherein the third connection unit is a connection of an n×2 coupler connected between the n signal compensation units and a single ring type optical communication line.

3. The WDM PON system according to claim 1, wherein the third connection unit is n 1×2 couplers, one side branched ends of one of which are alternately connected to one side branched ends of another coupler, and which divide and output signals, which are received from a single ring type optical communication line, and output signals, which are transmitted from the n signal compensation units via the branched paths, to the single ring type optical communication line.

4. The WDM PON system according to claim 1, wherein the third connection unit is a connection of n 1×2 couplers connected between the n signal compensation units and n ring type optical communication lines.

5. The WDM PON system according to claim 1, wherein the third connection unit is a connection of (n−1)/2 1×2 couplers connected to the signal compensation units and (n+1)/2 2×2 couplers connected to (n+1)/2 ring type optical communication lines.

6. The WDM PON system according to claims 2, wherein each of the signal compensation units comprises:
a first circulator configured to allow signals, output from the first connection unit, and signals, input to the first connection unit, to be transmitted and received through different paths;
a second circulator configured to allow signals output from the third connection unit and signals input to the third connection unit to be transmitted and received through different paths; and
a pair of amplifiers installed on two paths between the first and second optical circulators, and configured to amplify and compensate signals exchanged through the two paths.

7. The WDM PON system according to claims 2, wherein each of the signal compensation units comprises:
a 1×2 coupler configured to divide and output signals, output from the first connection unit, and output signals, transmitted through branched paths, to the first connection unit;
an optical circulator configured to allow signals, output from the third connection unit and signals, input to the third connection unit, to be transmitted and received through different paths; and
two amplifiers installed on two respective paths between the 1×2 coupler and the optical circulator in opposite directions, and configured to amplify and compensate signals transmitted and received through the two paths.

8. The WDM PON system according to claims 2, wherein each of the signal compensation units comprises:
a 1×2 coupler configured to divide and output a signal output from the first connection unit, and output signals, transmitted through branched paths, to the first connection unit;
an optical circulator configured such that signals output from the third connection unit and signals input to the third connection unit are transmitted and received through different paths; and
two amplifiers installed on two respective paths between the 1×2 coupler and the optical circulator in opposite directions, and configured to amplify and compensate signals transmitted and received through the two paths.

9. The WDM PON system according to claim 3, wherein each of the signal compensation units comprises:
a first circulator configured to allow signals, output from the first connection unit, and signals, input to the first connection unit, to be transmitted and received through different paths;
a second circulator configured to allow signals output from the third connection unit and signals input to the third connection unit to be transmitted and received through different paths; and
a pair of amplifiers installed on two paths between the first and second optical circulators, and configured to amplify and compensate signals exchanged through the two paths.

10. The WDM PON system according to claim 4, wherein each of the signal compensation units comprises:
a first circulator configured to allow signals, output from the first connection unit, and signals, input to the first connection unit, to be transmitted and received through different paths;
a second circulator configured to allow signals output from the third connection unit and signals input to the third connection unit to be transmitted and received through different paths; and
a pair of amplifiers installed on two paths between the first and second optical circulators, and configured to amplify and compensate signals exchanged through the two paths.

11. The WDM PON system according to claim 5, wherein each of the signal compensation units comprises:
a first circulator configured to allow signals, output from the first connection unit, and signals, input to the first connection unit, to be transmitted and received through different paths;
a second circulator configured to allow signals output from the third connection unit and signals input to the third connection unit to be transmitted and received through different paths; and
a pair of amplifiers installed on two paths between the first and second optical circulators, and configured to amplify and compensate signals exchanged through the two paths.

12. The WDM PON system according to claim 3, wherein each of the signal compensation units comprises:
a 1×2 coupler configured to divide and output signals, output from the first connection unit, and output signals, transmitted through branched paths, to the first connection unit;
an optical circulator configured to allow signals, output from the third connection unit and signals, input to the third connection unit, to be transmitted and received through different paths; and
two amplifiers installed on two respective paths between the 1×2 coupler and the optical circulator in opposite directions, and configured to amplify and compensate signals transmitted and received through the two paths.

13. The WDM PON system according to claim 4, wherein each of the signal compensation units comprises:
a 1×2 coupler configured to divide and output signals, output from the first connection unit, and output signals, transmitted through branched paths, to the first connection unit;
an optical circulator configured to allow signals, output from the third connection unit and signals, input to the third connection unit, to be transmitted and received through different paths; and
two amplifiers installed on two respective paths between the 1×2 coupler and the optical circulator in opposite directions, and configured to amplify and compensate signals transmitted and received through the two paths.

14. The WDM PON system according to claim 5, wherein each of the signal compensation units comprises:
a 1×2 coupler configured to divide and output signals, output from the first connection unit, and output signals, transmitted through branched paths, to the first connection unit;
an optical circulator configured to allow signals, output from the third connection unit and signals, input to the third connection unit, to be transmitted and received through different paths; and
two amplifiers installed on two respective paths between the 1×2 coupler and the optical circulator in opposite directions, and configured to amplify and compensate signals transmitted and received through the two paths.

15. The WDM PON system according to claim 3, wherein each of the signal compensation units comprises:
a 1×2 coupler configured to divide and output a signal output from the first connection unit, and output signals, transmitted through branched paths, to the first connection unit;
an optical circulator configured such that signals output from the third connection unit and signals input to the third connection unit are transmitted and received through different paths; and
two amplifiers installed on two respective paths between the 1×2 coupler and the optical circulator in opposite directions, and configured to amplify and compensate signals transmitted and received through the two paths.

16. The WDM PON system according to claim 4, wherein each of the signal compensation units comprises:
a 1×2 coupler configured to divide and output a signal output from the first connection unit, and output signals, transmitted through branched paths, to the first connection unit;
an optical circulator configured such that signals output from the third connection unit and signals input to the third connection unit are transmitted and received through different paths; and
two amplifiers installed on two respective paths between the 1×2 coupler and the optical circulator in opposite directions, and configured to amplify and compensate signals transmitted and received through the two paths.

17. The WDM PON system according to claim 5, wherein each of the signal compensation units comprises:
a 1×2 coupler configured to divide and output a signal output from the first connection unit, and output signals, transmitted through branched paths, to the first connection unit;
an optical circulator configured such that signals output from the third connection unit and signals input to the third connection unit are transmitted and received through different paths; and
two amplifiers installed on two respective paths between the 1×2 coupler and the optical circulator in opposite directions, and configured to amplify and compensate signals transmitted and received through the two paths.
